(19) United States
(12) Patent Application Publication
(10) Pub. No.: US 2011/0252185 A1
(43) Pub. Date: Oct. 13, 2011

(54) Method Of Operating A NAND Memory Controller To Minimize Read Latency Time

(75) Inventor: Siamak Arya, Cupertino, CA (US)

(73) Assignee: Silicon Storage Technology, Inc.

(21) Appl. No.: 12/756,965

(22) Filed: Apr. 8, 2010

(51) Int. Cl. G06F 12/00; G06F 12/10

(52) U.S. Cl. 711/103; 711/209; 711/E12.001; 711/E12.008

(57) ABSTRACT

A NAND memory chip has a plurality of blocks with each block having a certain amount of storage and wherein the amount of storage in each block is the minimum amount that is erasable as a group. A controller controls the NAND memory chip. The method of operating the controller comprises writing data into a block of the NAND memory chip to partially fill the block. Then the controller tracks the extent to which the block has been written. After the block is partially written, the step is stopped. The controller determines if a request to the NAND memory chip needs to be serviced. The controller resumes the writing into the block after servicing the request. The present invention also relates to a method for controlling, the operation of a memory device having a controller for interfacing with and controlling a NAND memory. The memory device is responsive to either serial or parallel ATA protocol commands supplied from a host.

### TECHNICAL FIELD

The present invention relates to a method of operating a NAND memory controller as well as a method to operate a memory device comprising a NAND memory controller and a NAND integrated circuit chip. The method of the present invention reduces the maximum access latency time.

### BACKGROUND OF THE INVENTION

NAND memory integrated circuit chips are well known in the art. In a NAND memory chip, the memory is characterized by a number of blocks of storage, with each block containing a number of pages. The total amount of storage in each block is the minimum erasable unit. Further, a block of NAND storage that has already been written or programmed, cannot be programmed again until it is erased. Therefore, in a block based flash file system (FFS), when replacing or overwriting a portion of a prewritten block, the overwrite data and the unchanged data portion of the block must be merged into a new erased block. Thus, as shown in FIG. 1. if pages 2 and 3 of a block are over written, those pages are saved in a temporary block, and then are merged with the original block into a new block. Therefore, pages 0 and 1 are copied from original block, pages 2 and 3 are copied from the temporary block, and the rest of the pages are copied from page 4 to end of the original block. The original and temporary blocks are then erased for future use.

The merge operation can be very long when a block of NAND has 128 or 256 pages and moving each page may take multiple milliseconds. In addition, as the size of the blocks and programming time are increasing, the merge time will increase.

In many real time applications, there is a limit on access latency. For example, in a Set-Top-Box, STB, application, if the data cannot be read in a timely manner, some frames of data will be missed and the resulting video will not be acceptable. Even though most STBs use some buffering, but if the read falls behind a write that causes a very long merge, by the time the read is serviced, many frames may have been missed. Therefore, a mechanism is required to limit the maximum access latency to avoid missing frames or overflowing write buffers.

### SUMMARY OF THE INVENTION

This limitation is overcomed by the present invention wherein a method of operating a controller for controlling a NAND memory chip is disclosed. The NAND memory chip has a plurality of blocks with each block having a certain amount of storage and wherein the amount of storage in each block is the minimum amount that is erasable as a group. The method operating the controller comprises writing data into a block to partially fill the block. The controller tracks the extent to which the block has been written. After the block is partially written, the step is stopped. The controller determines if a request to the NAND memory chip needs to be serviced. The controller resumes the writing into the block after servicing the request.

The present invention also relates to a method for controlling the operation of a memory device having a controller for interfacing with and controlling a NAND memory. The memory device is responsive to either serial or parallel ATA protocol commands supplied from a host.

### BRIEF DESCRIPTION OF THE DRAWINGS

FIG. 1 is a block diagram of a merge operation of the prior art.

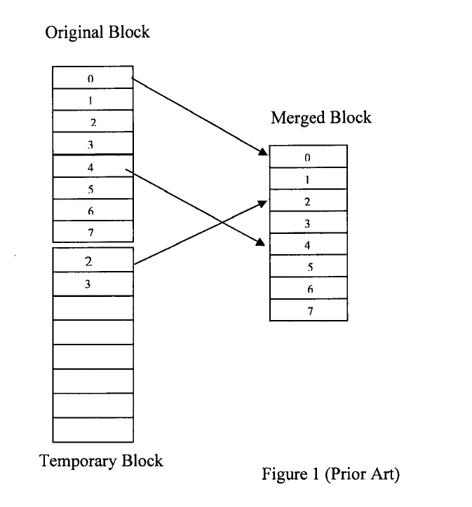

FIG. 2 is a block diagram of a controller operating with the method of the present invention to control a NAND memory chip and receiving commands from a host device.

FIG. 3 is a diagram showing the address space for a NAND memory chip and the type of operation to which the method of the present invention is applicable.

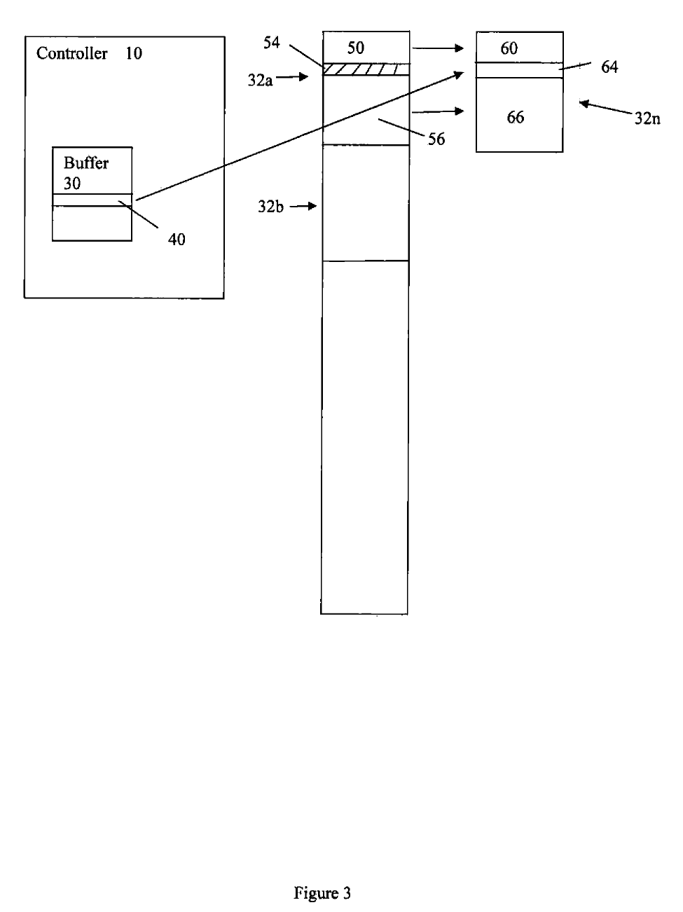

### DETAILED DESCRIPTION OF THE PREFERRED EMBODIMENT

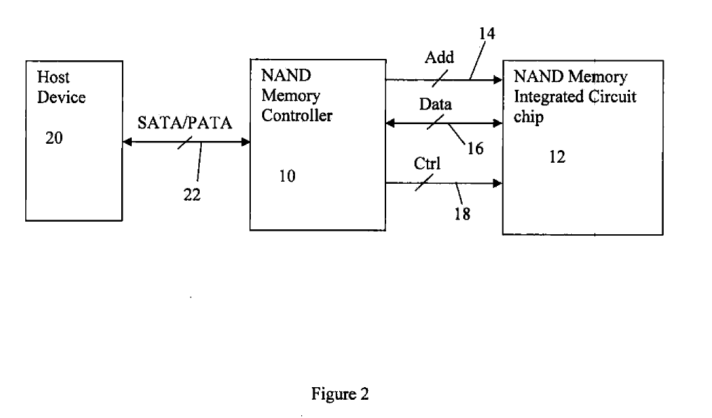

Referring to FIG. 2 there is shown a block level diagram of a NAND memory controller 10 operating with the method of the present invention. The controller 10 interfaces with and controls the operation of a NAND memory integrated circuit chip 12, through well known buses, such as an address bus 14, a data bus 16 and a control bus 18. Although the present invention is a method for operating the memory controller 10, the present invention can also be used to operate a memory device comprising the controller 10 and the NAND memory chip 12 packaged together as a memory module or even integrated together.

The controller 10 interfaces with a host device 20, through well known protocols, such as PATA (parallel ATA) or SATA (Serial ATA) command protocols.

As described heretofore, the present invention solves the problem of a long latency time between when a read request is issued by the host device 20 and when data is received by the host device 20 in response to the read request, and especially, when the read request is issued while the controller 10 is controlling the NAND memory chip 12 during a merge or write operation.

Because of the nature of the NAND memory chip 12, there are many instances when a write command is being executed by the controller 10 on the NAND memory chip 12, even when no write command is issued by the host device 20. For example, as discussed hereinabove, in a so called merge operation, the controller 10 will merge the data that is stored in various pages in different blocks into a single block. This is seen by reference to FIG. 2. A block 32a, contains a number of pages of data 50, and 56 that need to be merged with pages of data 40 from block 30, into a single block 32n. The data from pages 54 are to be replaced by data from pages 40. The controller 10 will cause the NAND memory chip 12 to cause data from pages 50 in block 32a to be written into pages 60 in block 32n, data from pages 40 in block 30 to be written into pages 64 of block 32n, and data from pages 56 of block 32a to be written into pages 66 of block 32n. As previously discussed, in the prior art, in such an operation, the write operation commences to write to the entire block 32n, and does not cease until the entire block 32n is written. As the number of pages per block has increased, the time to complete the merge operation becomes longer.

A further type of operation that requires a write, but is not dependent explicitly on a write command from the host 20 is a so-called garbage collection operation. In this case, (similar to a merge operation, valid data from a block are removed and written into a block filling the block, and the invalid data in the other blocks are then erased, with the data in a block erased together.

The present invention is applicable to any type of write operation whether the write operation is the result of a write initiated command from the host device 20 or is a write operation initiated by the controller 10 for “house keeping” operation on the NAND memory chip 12, such as a merge operation or a garbage collection operation.

In the present invention, the controller 10 is a microcontroller and operates on a computer program stored in its memory or downloaded from the NAND memory chip 12. The program causes the controller 10 to operate in the following manner. As before, the controller 10 begins the write operation into a block in the NAND integrated chip 12. However, the controller 10 causes only a portion of the block to be written. During the time, the block is being written, the controller 10 tracks the extent to which the block has been written. One example of tracking is to create an index table correlating the physical page(s) within the block that has been written with the logical address of the data that was written into those page(s) of the block. As each page is written, or during the writing of each page, the index is updated. After the block is partially written, the controller 10 stops the writing operation. The amount of time or the number of pages by which the block is partially written before stopping, will be explained hereinafter.

After the certain amount of time or number of pages have been written, the controller 10 stops the write operation. The controller 10 then detects, by e.g. polling the host device 20 whether another operation, such as read operation needs to be service. In the event, another request, such as a read operation is received, then the controller 10 services the read request. Once the read request has been serviced, the controller 10, and assuming no other read request has been received, returns to complete the partial write operation, using the index which it created to determine where to write the next page of data. For all requests other than a read request, the controller 10 may choose to service that request or wait until the writing operation of the entire block is completed. Of course, in the event, no service request is received after the controller 10 stops the partial write operation, then the controller 10 can continue the write operation to complete the write operation to the entire block.

The number of pages of data that is written or the amount of time that the partial write operation is permitted to complete before the controller 10 stops the operation is dependant upon the amount of read latency time, the controller 10 is designed to tolerate. For example, if a read operation is received immediately after a partial write operation commences, then the maximum amount of time, the controller 10 should continue the partial write operation is the maximum read latency time the controller 10 is designed to tolerate. In applications where the controller 10 along with the NAND memory chip 12 is used to supply video data, then the maximum read latency time might be the determined by the amount of buffer present. In any event, upon resuming the write operation the controller 10 uses the index created during the partial write operation to continue the write operation where the controller 10 had stopped. In addition, the index created during the partial write operation may also be used in the event a rear request was received and the read requested directed to logical address of the data that was just written.

The method of the present invention can also be used by the NAND controller 10 operating with a NAND memory chip 12, as a memory module, with either the controller 10 and the NAND chip 12 integrated into a module, or with the controller 10 and the NAND memory 12 integrated in a single integrated circuit chip. In that event, the controller 10 can provide various interfaces to a host device 20. One form of memory interface is the well known interface of SATA or serial ATA interface. Another interface is the PATA or parallel ATA interface. Since the interfaces differ, operation of the controller 10 with the method of the present invention will be explained with regard to each type of interface.

In a SATA interface, as the controller 10 operates on a command, e.g. a write command from the host device 20 or even an internally generated write operation such as a merge write operation, other commands can be received by the controller 10 from the host 20 and stored in a buffer (not shown) within the controller 10. This is well known from the well known SATA interface protocol.

In the event the controller 10 interfaces with the host device 20 in accordance with the SATA interface, the method of the present invention operates as follows. The controller 10 begins the partial write operation into a new block as previously discussed. Because in accordance with the SATA interface, other commands, such as a read command, from the host device 20 can be received by the controller 10, the controller 10 also checks the commands received from the host device 20 as it performs the task of partially writing into a new block. In the event, a read command is received while the partial write operation is occurring, then after a predetermined amount of time (or after a predetermined number of pages are written), the controller 10 stops the partial write operation to service the read request. As before, the controller 10 also tracks the extent to which data is written into the new block by creating an index. Once the read command is serviced, then the controller 10 resumes the write operation to complete the writing of the block. In the event no read command is received during the time period the partial write operation was occurring, then the controller 10 continues to complete the writing into the block, without stopping the partial write step to check for read commands.

Alternatively, in the operation of the controller 10 which is connected to the host 20 via a SATA interface, the controller 10 initiates a partial write operation to a new block in the NAND memory 12. As the controller 10 writes partially into the new block, it also creates on index to track the extent to which pages in the new block have been written into. After the requisite amount of time or the number of pages have been written, the controller 10 stops the partial write operation and checks to see if any request command, and in particular read command was received from the host device 20 during the time the controller 10 was performing the partial write operation. If no command or no read command was received during the partial write operation, then the controller 10 resumes the write operation to complete the writing of the new block. Of course, if the block is large, then the act of resuming writing may entail resuming another partial write rather than writing the new block completely.

In the event the controller 10 interfaces with the host device 20 in accordance with the PATA interface, the method of the present invention operates as follows. Because in the PATA interface, commands from the host device 20 are received by the controller 10 only if the controller 10 is not performing any other write or read command, the controller 10 operates similar to the alternative method for the SATA interface as described above. In particular, the controller 10 initiates a partial write operation to a new block in the NAND memory 12. As the controller 10 writes partially into the new block, it also creates an index to track the extent to which pages in the new block have been written into. After the requisite amount of time or the number of pages have been written, the controller 10 stops the partial write operation and notifies the host 20 of its availability to service commands from the host device 20. The controller 10 then checks to see if any command, and in particular read command is received. If no read command is received, then the controller 10 resumes the write operation to complete the writing of the new block. Of course, if the block is large, then the act of resuming writing may entail resuming another partial write rather than writing the new block completely.

What is claimed is:

1. A method of operating a controller for controlling a NAND memory chip, wherein said NAND memory chip has a plurality of blocks with each block having a certain amount of storage, wherein the amount of storage in each block is the minimum amount that is erasable as a group, wherein said method comprising:
writing data into a block to partially fill the block;
tracking the extent to which said block has been written;
stopping the writing after said block is partially written;
detecting if a request to the NAND memory chip needs to be serviced; and
resuming the writing into said block after servicing the request.

2. The method of claim 1 wherein said request is a read operation.

3. The method of claim 2 wherein the amount of data written into said block during the writing step is determined by the total amount of time the writing step would take.

4. The method of claim 3 wherein said block comprises a plurality of pages.

5. The method of claim 3 wherein said tracking step comprises:
creating an index of the logic address to the new physical address of data written into said block.

6. The method of claim 5 wherein said resuming step comprises retrieving the index created to determine the extent to which data has been written into the block, and continuing the writing therefrom.

7. A method of operating a memory device having a controller for interfacing with and controlling a NAND memory, wherein said NAND memory has a plurality of blocks with each block having a certain amount of storage, wherein the amount of storage in each block is the minimum amount that is erasable as a group, wherein said memory device is responsive to parallel ATA protocol commands supplied from a host, wherein said method comprising:
responding to a write command by writing data into a block to partially fill the block;
tracking the extent to which said block has been written;
stopping the writing after said block is partially written;
reporting to the host of the memory device's readiness to receive another command; and
resuming the writing into said block if no read command is received from the host.

8. The method of claim 7 wherein said request is a read operation.

9. The method of claim 8 wherein the amount of data written into said block during the writing step is determined by the total amount of time the writing step would take.

10. The method of claim 9 wherein said block comprises a plurality of pages.

11. The method of claim 9 wherein said tracking step comprises:
creating an index of the logic address to the new physical address of data written into said block.

12. The method of claim 11 wherein said resuming step comprises retrieving the index created to determine the extent to which data has been written into the block, and continuing the writing therefrom.

13. A method of operating a memory device having a controller for interfacing with and controlling a NAND memory, wherein said. NAND memory has a plurality of blocks with each block having a certain amount of storage, wherein the amount of storage in each block is the minimum amount that is erasable as a group, wherein said memory device is responsive to serial ATA protocol commands supplied from a host, wherein said method comprising:
responding to a write command by writing data into a block to partially fill the block;
checking to determine if any request command is received during the step of writing data into the block;
tracking the extent to which said block has been written; and
continuing the writing into said block if no request command is received.

14. The method of claim 13 wherein said request is a read operation.

15. The method of claim 14 wherein the amount of data written into said block during the writing step is determined by the total amount of time the writing step would take.

16. The method of claim 15 wherein said block comprises a plurality of pages.

17. The method of claim 15 wherein said tracking step comprises:
creating an index of the logic address to the new physical address of data written into said block.

18. A method of operating a memory device having a controller for interfacing with and controlling a NAND memory, wherein said NAND memory has a plurality of blocks with each block having a certain amount of storage, wherein the amount of storage in each block is the minimum amount that is erasable as a group, wherein said memory device is responsive to serial ATA protocol commands supplied from a host, wherein said method comprising:
responding to a write command by writing data into a block to partially fill the block;
tracking the extent to which said block has been written;
stopping the writing, after said block is partially written;
checking to determine if any request command is received by the memory device after the writing step; and
resuming the writing into said block if no request command is received.

19. The method of claim 18 wherein said request is a read operation.

20. The method of claim 19 wherein the amount of data written into said block during the writing step is determined by the total amount of time the writing step would take.

21. The method of claim 20 wherein said block comprises a plurality of pages.

22. The method of claim 20 wherein said tracking step comprises:
creating an index of the logic address to the new physical address of data written into said block.

23. The method of claim 22 wherein said resuming step comprises retrieving the index created to determine the extent to which data has been written into the block, and continuing the writing therefrom.
